(19) United States
(12) Patent Application Publication
(10) Pub. No.: US 2012/0292324 A1
(43) Pub. Date: Nov. 22, 2012

(54) SUCTION FREE GARBAGE CAN

(76) Inventor: JOSEPH SZAFRANSKI, Lockport, NY (US)

(21) Appl. No.: 13/109,731

(22) Filed: May 17, 2011

(51) Int. Cl. B65F 1/14; B65F 1/06

(52) U.S. Cl. 220/495.06; 220/745

(57) ABSTRACT

The present invention is a garbage can with a plurality of sides and a top used in combination with a trash bag that includes two air tubes with two ends that are disposed on the inside sides of the garbage can with a tapered bottom. The garbage can has the two air tubes molded on the inside and sides of the garbage can and are on opposite sides of the inside of the can facing each other. The air tube ends are tapered approximately 1 inch from the bottom of the garbage can to prevent a trash bag from getting snagged on the ends of the air tubes and are recessed approximately 1 inch lower than the top of the garbage can.

### TECHNICAL FIELD & BACKGROUND

Currently there have been minimal developments in the field of trash cans and trash receptacles. Traditional garbage cans, due to limited space for flexibility, cause liners to rip and fall over when one attempts to remove them from the trash can basin, often resulting in a frustrating process requiring tedious clean-up.

The present invention generally relates to a garbage can. More specifically, the invention is a suction free garbage can.

It is an object of the invention to provide a suction free garbage can that eliminates trash bag malfunction during waste disposal.

It is an object of the invention to provide a suction free garbage can that prevents a garbage can bag from becoming struck in a garbage can by allowing air flow beneath the garbage can bag.

It is an object of the invention to provide a suction free garbage can that prevents a garbage can bag from tearing as it is being removed from a garbage can.

What is really needed is a suction free garbage can that eliminates trash bag malfunction during waste disposal, prevents a garbage can bag from becoming struck in a garbage can by allowing air flow beneath the garbage can bag and prevents a garbage can bag from tearing as it is being removed from a garbage can.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates an overhead perspective view of a garbage can, in accordance with one embodiment of the present invention.

FIG. 1B illustrates a side perspective view of a garbage can, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

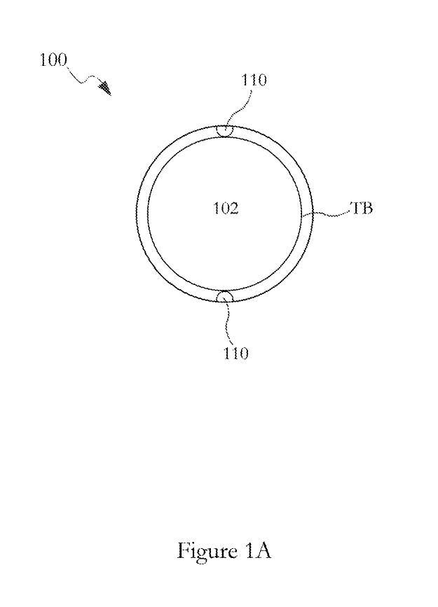

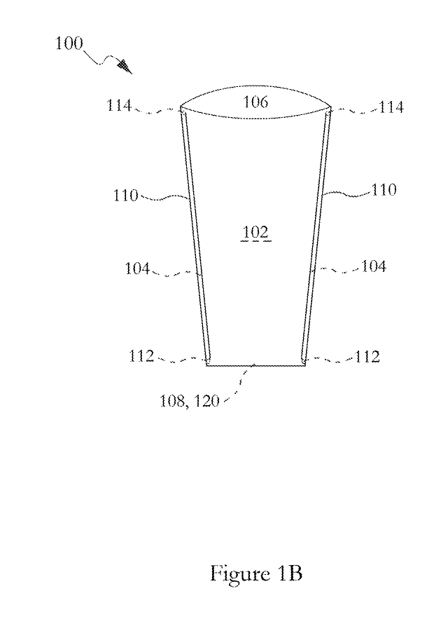

FIG. 1A illustrates an overhead perspective view of a garbage can 100, in accordance with one embodiment of the present invention. The garbage can 100 includes a plurality of air tubes 110. The air tubes 110 include two air tubes that are molded and disposed on the inside 102 of the garbage can 100 on opposite ends facing each other at a 180 degree juxtaposition on each side 104 of the inside 102 of the garbage can 100, although any suitable number of air tubes can be utilized. The two air tubes 110 are approximately ½″ diameter air tubes, although other suitable sized air tubes can also be utilized. The garbage can 100 can be made of plastic, metal or other suitable material and can be a 10-15 gallon, 20-30 gallon, 33 gallon, 45-50 gallon garbage can or other suitable size garbage can.

FIG. 1B illustrates a side perspective view of a garbage can 100, in accordance with one embodiment of the present invention. The air tubes 110 extend vertically from the top 106 of the garbage can 100 to approximately 1 inch from the bottom 108 of the garbage can 100 and remain open at the ends 112,114 of the air tube, although other suitable distances from the bottom 108 of the garbage can be utilized. The air tubes 110 are also recessed approximately 1 inch from the top 106 of the garbage can 100 and remain open at the ends 112,114 of the air tubes, although other suitable distances from the top 106 of the garbage can can be utilized. The air tubes 110 allow air to be pulled into the bottom 108 of the garbage can while a trash bag TB is pulled from the top 106 of the garbage can as a person removes the trash bag TB from the garbage can 100. The bottom 108 of the garbage can is a tapered bottom 120 to further assist in a relatively easy and more facilitated trash bag TB removal.

When a trash bag TB is full, the trash bag TB creates a seal on the sides 104 of the garbage can it is placed in, creating suction under the trash bag TB when it is pulled out. Air flow within the garbage can 100 through the air tubes 110 disposed on the inside 102 of the garbage can would eliminate the suction, preventing the trash bag TB from tearing or having to hold down the garbage can 100. The air tubes 110 are tapered approximately 1 inch from the bottom 108 of the garbage can to prevent the trash bag TB from getting snagged on the ends 112,114 of the air tubes. The air tubes 110 may also be recessed approximately 1 inch lower than the top 106 of the garbage can to accommodate any style of lid (not shown) utilized with the garbage can 100.

The garbage can serves as an air circulating receptacle that prevents standardized trash bags from adhering to the sides of a waste basin. Made from plastic or metal materials, the garbage can includes two internal air flow tubes, each approximately ½ inch in diameter, positioned on opposing sides of a 13 gallon or other suitable sized trash can. Extending vertically from the top to approximately 1 inch from the basin's foundation, the tapered air tubes allow circulation underneath the trash bag, preventing friction as it is being discarded. The garbage can may be marketed to both private and commercial consumers alike.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A garbage can with an inside with a plurality of sides and a top, comprising:
a plurality of air tubes that are disposed on said inside sides of said can; and
a tapered bottom,

2. The garbage can according to claim 1, wherein said air tubes are molded on said inside and sides of said can.

3. The garbage can according to claim 1, wherein said air tubes are two air tubes.

4. The garbage can according to claim 1, wherein said garbage can is a selected one of the group consisting of a 10-15 gallon, a 20-30 gallon, a 33 gallon or a 45-50 gallon garbage can.

5. The garbage can according to claim 1, wherein said garbage can is a selected one of the group consisting of a plastic or a metal garbage can.

6. A garbage can with an inside with a plurality of sides and a top, comprising:
a plurality of air tubes that are disposed on said inside sides of said can; and
a tapered bottom.

7. The garbage can according to claim 6, wherein said air tubes are molded on said inside and sides of said can.

8. The garbage can according to claim 6, wherein said air tubes are two air tubes.

9. The garbage can according to claim 8, wherein said two air tubes are on opposite said sides of said inside of can facing each other.

10. The garbage can according to claim 9, wherein said two air tubes are at 180 degree juxtaposition to each other.

11. The garbage can according to claim 6, wherein said garbage can is a selected one of the group consisting of a 10-15 gallon, a 20-30 gallon, a 33 gallon or a 45-50 gallon garbage can.

12. The garbage can according to claim 6, wherein said garbage can is a selected one of the group consisting of a plastic or a metal garbage can.

13. A garbage can with an inside with a plurality of sides and a top used in combination with a trash bag, comprising:
a plurality of air tubes with two ends that are disposed on said inside sides of said can; and
a tapered bottom.

14. The garbage can according to claim 13, wherein said air tubes are molded on said inside and sides of said can.

15. The garbage can according to claim 13, wherein said air tubes are two air tubes.

16. The garbage can according to claim 15, wherein said two air tubes are on opposite said sides of said inside of can facing each other at a 180 degree juxtaposition to each other.

17. The garbage can according to claim 13, wherein said air tube ends are tapered approximately 1 inch from said bottom of said garbage can to prevent said trash bag from getting snagged on said ends of said air tubes.

18. The garbage can according to claim 13, wherein said air tubes are recessed approximately 1 inch lower than said top of said garbage can.

19. The garbage can according to claim 13, wherein said garbage can is a selected one of the group consisting of a 10-15 gallon, a 20-30 gallon, a 33 gallon or a 45-50 gallon garbage can.

20. The garbage can according to claim 13, wherein said garbage can is a selected one of the group consisting of a plastic or a metal garbage can.
